(19) United States
(12) Patent Application Publication
(10) Pub. No.: US 2017/0144861 A1
(43) Pub. Date: May 25, 2017

(54) ELEVATOR COMPRISING BALANCE ROPE TENSIONING DEVICE

(71) Applicant: ThyssenKrupp Elevator AG, Essen (DE)

(72) Inventor: Manfred Häfele, Filderstadt (DE)

(73) Assignee: ThyssenKrupp Elevator AG, Essen (DE)

(21) Appl. No.: 15/127,333

(22) PCT Filed: Mar. 20, 2015
(86) PCT No.: PCT/EP2015/055939

§ 371 Date: Sep. 19, 2016

(30) Foreign Application Priority Data
Mar. 21, 2014 (DE) 10 2014 103 951.3
Mar. 24, 2014 (DE) 10 2014 104 047.3

(51) Int. Cl. B66B 7/10; B66B 9/00

(52) U.S. Cl. CPC B66B 7/10; B66B 9/00

(57) ABSTRACT

A lift system may include a car and a counterweight that can be moved on a shaft-side counterweight guide. The car and the counterweight may be connected to one another by way of a balance rope. The balance rope can be tensioned by a balance rope tensioning apparatus. The balance rope tensioning apparatus may have a tensioning roller that is mounted on the shaft-side counterweight guide and can be moved along the shaft-side counterweight guide.”

The present invention relates to a lift having a balance rope tensioning apparatus.

The use of balance ropes in traction lifts or traction-sheave lifts is known. Balance ropes of this kind serve for weight compensation of variable forces which occur on account of the inherent weight of a suspension cable in different positions of the car during operation of the lift.

Balance rope tensioning apparatuses are known in this connection and serve for tensioning the balance rope, as a result of which oscillation of the rope can be kept low, and also jumping of the counterweight or of the lift cab can be minimized or entirely prevented.

The term “balance rope” used in this document is intended to include all types of compensation ropes, compensation chains, belts or similar structures.

EP 1 142 815 B1 discloses a lift having a tensioning apparatus for at least one balance rope which connects a car and a counterweight of a lift which moves in a shaft, wherein the tensioning apparatus has two tensioning rollers, wherein the two tensioning rollers are arranged in an offset manner in relation to the vertical and the horizontal.

The described design requires a large amount of installation space beneath the car, as a result of which a corresponding shaft pit depth is required.

According to the present invention, the aim is therefore to provide a more compact structure for a balance rope tensioning apparatus.

The object is achieved by a lift having the features of Patent Claim 1.

The balance rope tensioning apparatus used within the scope of the present invention is distinguished in that it has a tensioning roller which is designed such that it can be moved along a shaft-side counterweight guide which is provided in any case. A counterweight guide is therefore additionally used as a guide for the balance rope tensioning apparatus. The balance rope tensioning apparatus used in the prior art and situated beneath the car can be dispensed with according to the invention. This provides, for example, a greater degree of flexibility in respect of utilization of the shaft space beneath the car.

The term “shaft-side counterweight guide” is to be understood to mean, in particular, the components of an apparatus for guiding the counterweight along the length of the shaft, which components cannot be moved and are fastened in the lift shaft. A “shaft-side counterweight guide” of this kind interacts, for example, with guide shoes or roller guides which are formed on the counterweight frame (which can be moved). A shaft-side counterweight guide comprises, in particular, guide rails and has, in particular, two guide rails which run in parallel and between which the balance rope tensioning apparatus is at least partially provided or arranged.

Further advantageous refinements of the invention are the subject matter of the dependent claims.

The balance rope tensioning apparatus is advantageously designed in such a way that the tensioning roller can be moved vertically, independently of the counterweight.

With preference, the tensioning roller, which can be moved, of the balance rope tensioning apparatus beneath the movement path of the counterweight can be moved on the shaft-side counterweight guide or the guide rails of the said counterweight guide. By virtue of this measure, a shaft-side counterweight guide, which is longer than the actual movement path of the counterweight, can be utilized in an optimum manner.

The balance rope tensioning apparatus expediently has at least one further fixed roller. This roller can be formed, for example, on the shaft-side counterweight guide or else in another suitable position in the lift shaft. Further rollers of this kind can be used to stabilize the balance rope or else to deflect the balance rope.

With preference, the balance rope tensioning apparatus is designed with a tensioning mass. This tensioning mass can expediently be designed such that it can be moved, together with the tensioning roller which can be moved, along the shaft-side counterweight guide.

The balance rope tensioning apparatus used within the scope of the present invention is, in particular, designed in such a way that it has one tensioning roller and one tensioning weight which are arranged entirely outside the projection area of the cab.

It has proven particularly expedient for the balance rope to be fastened to the suspension point on the car and to the suspension point on the counterweight using a suspension ratio of 1:1. The illustrated exemplary embodiments (see below) relate to a suspension ratio of 1:1 of this kind.

With particular preference, the balance rope is fastened to two suspension points on the counterweight, wherein the said balance rope is guided to the car from the first suspension point, and is guided back again from the car to a second suspension point on the counterweight.

Conversely, it is also possible for the balance rope to be fastened to two suspension points on the car, wherein the said balance rope is guided to the counterweight from a first suspension point, and is guided back again from the counterweight to a second suspension point on the car.

The cited features and those described in the text which follows can be used both in the respectively indicated combinations and also in other combinations or on their own, without departing from the scope of the invention.

A preferred embodiment of the lift according to the invention will now be explained in greater detail with reference to the appended drawing, in which:

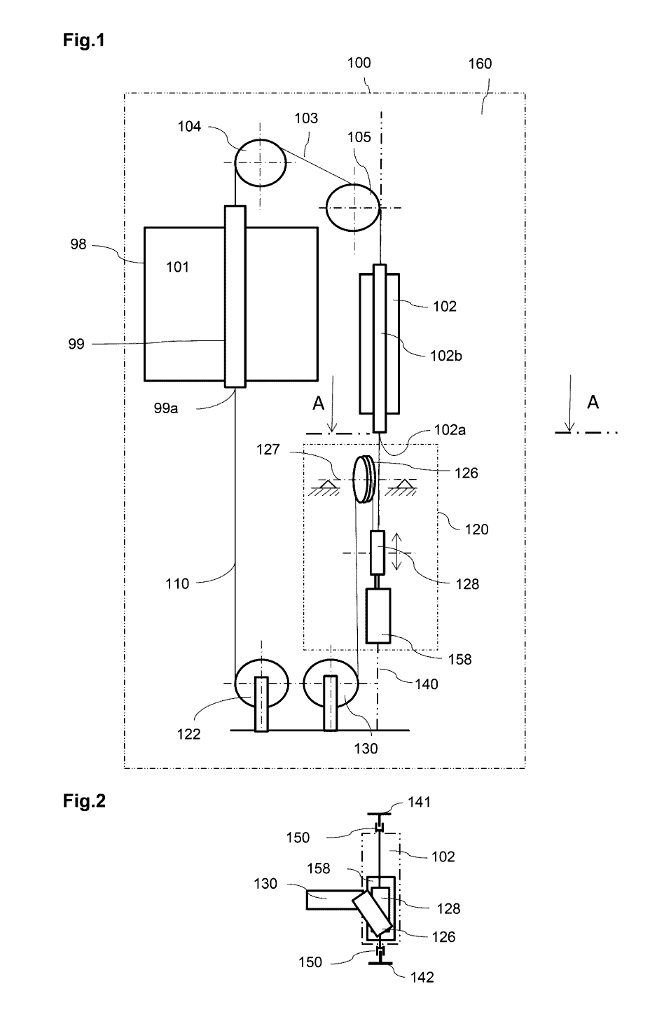

FIG. 1 is a schematic illustration of a preferred embodiment of a lift system according to the invention from the side,

FIG. 2 shows a plan view along section line A-A in FIG. 1 of a counterweight guide which has two rails, wherein the contour of the counterweight is additionally illustrated for reasons of clarity,

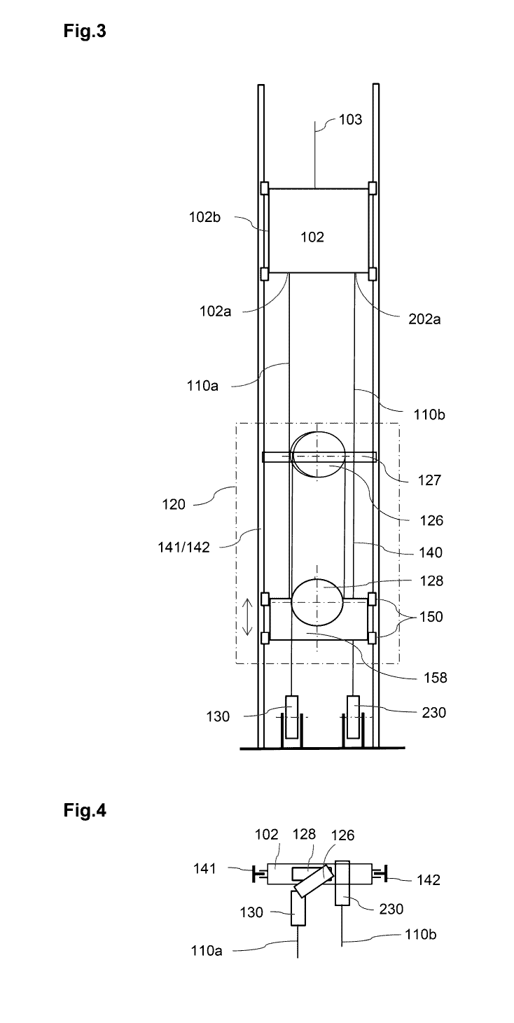

FIG. 3 shows a plan view of a counterweight guide for illustrating a further preferred embodiment of the lift system according to the invention, and

FIG. 4 shows a view of the counterweight guide according to FIG. 3 which substantially corresponds to the view in FIG. 2.

In FIG. 1, a first preferred embodiment of a lift system according to the invention which is formed in a shaft 160 is designated 100 overall. The lift system 100 has a car 101 and a counterweight 102 which are connected to one another by means of a suspension cable 103.

The car 101 has a lift 98 and a car frame 99. The suspension cable 103 is guided by means of a traction sheave 104 and a further deflection roller 105. The car 101 can be moved on a shaft-side car guide, not illustrated in detail, which has, for example, corresponding guide rails, and the counterweight 102 can be moved on a shaft-side counterweight guide 140.

For the purpose of weight compensation amongst other things, the car 101 and the counterweight 102 are also connected to one another by means of a balance rope 110. In this case, the balance rope 110 is guided by means of a balance rope tensioning apparatus, designated 120 overall, and further rollers 122, 130. On the car side, the balance rope 110 is fastened to a first suspension point 99a of the car frame 99 of the car 101.

On the counterweight side, the balance rope 110 is fixed to a second suspension point 102a of a counterweight frame 102b of the counterweight 102.

The balance rope tensioning apparatus 120 has a first roller 126 which is fixed, or cannot be moved, in the shaft and can be rotated about an axis (not illustrated), and has a second roller 128 which can be moved vertically in the shaft and can be rotated about an axis (likewise not illustrated). The further deflection rollers 122, 130 which can be rotated about the respective axes serve to deflect the balance rope 110 beneath the balance rope tensioning apparatus towards the suspension point 99a.

The balance rope tensioning apparatus 120 will now be explained in greater detail, in particular also with reference to FIGS. 2 to 4.

FIGS. 1 and 2, which relate to the first preferred embodiment of a lift system according to the invention, show that the counterweight 102 is designed such that it can be moved on the shaft-side counterweight guide 140 which has two rails 141, 142. The balance rope tensioning apparatus 120 has, as mentioned, a first fixed roller 126 which is preferably mounted on a support 127 which is fastened to the rails 141, 142, and also has a vertically mobile tensioning roller 128.

The tensioning roller 128 is connected to a tensioning mass 158 of suitable dimensions. The tensioning roller is mounted on the rails 141, 142 together with the tensioning mass which is expediently provided with suitable guides 150. As a result, the tensioning roller 128 can accordingly be moved vertically along the shaft-side counterweight guide 140. The tensioning roller is provided with a damper device (not illustrated) which corresponds to the prior art. The said damper device is supported against the support 127 of the fixed roller 126 or against a further support which is mounted on the counterweight rails 141, 142 or on the shaft wall.

As already explained with reference to FIG. 1, the balance rope 110 is fastened to the suspension point 102a of the frame 102b of the counterweight 102. This suspension point 102a is preferably located at the centre of the bottom face of the frame 102b or of the counterweight 102. The balance rope 110 first extends vertically downward from this suspension point 102a, past the roller 126 (without making contact with the said roller), as far as the tensioning roller 128. The said balance rope is then guided around the tensioning roller 128, vertically upward back to the roller 126, around the said roller 126, and then again vertically downwards to the roller 130 at which it is deflected, for example, in a horizontal direction. The further profile of the balance rope 110, that is to say possibly by means of the further roller 122, illustrated in FIG. 1, to the suspension point 99a on the car frame 99, is shown in FIG. 1, but is not illustrated in FIG. 2.

In order that the rope which runs from the counterweight 102 to the tensioning roller 128 can be guided past the fixed roller 126, and also that the rope 110 which runs from the fixed roller 126 to the deflection roller 130 can be guided past the tensioning roller 128, the tensioning roller 128 and the fixed roller 126 are inclined in relation to one another. As an alternative, an inclined position can be dispensed with by appropriately designing the groove profiles and radially offsetting the two rollers.

The balance rope tensioning apparatus 120 according to the invention is distinguished in that, in a vertical projection on a horizontal plane, it can be positioned completely outside the projection area of the car 101, this being advantageous particularly with shallow shaft pit depths. FIG. 2 shows, for example, that the roller 126 and the tensioning roller 128 lie substantially completely in the projection area of the counterweight 102.

Overall, a shallower shaft pit depth can be achieved when the balance rope tensioning apparatus according to the invention is used. This is advantageous particularly with lift systems in which several cars move within one shaft (depending on one another or independently of one another) since, in lift systems of this kind, the counterweight is not moved over the entire length of the shaft-side counterweight guide or of the counterweight track.

The balance rope tensioning apparatus according to the invention can also be advantageously used for single lifts. Particular advantages are achieved with counterweights which are relatively wide, and therefore relatively wide rollers (in particular tensioning rollers) can also be positioned completely in the projection of the counterweight.

The position of the deflection roller 130 with respect to the tensioning roller 128 and the roller 126 will now be explained in greater detail, once again with reference to FIG. 2.

In the embodiment according to FIG. 2, two deflection rollers 130, 122 are provided in order to guide the balance rope to the suspension point 99a of the car frame 99. However, the roller 130 can also be arranged at a suitable angle in relation to the tensioning roller 128, so that, given a corresponding size of the deflection roller 130, the balance rope 110 can be deflected to the suspension point 99a on the car frame 99 solely by means of the roller 130.

FIGS. 3 and 4 illustrate a second preferred embodiment of the lift system according to the invention. Identical or similar components, as have already been described with reference to FIGS. 1 and 2, are provided with the same reference symbols and will not be explained in detail again.

In the first instance, this second embodiment differs from the first embodiment in that the balance rope 110 is not fastened centrally, but rather towards the side, to a first suspension point 102a on the bottom face of the counterweight 102.

This embodiment further differs from the first embodiment in that the balance rope 110 is initially guided, as in the first embodiment, from the suspension point 102a of the counterweight 102, via the fixed roller 126, the tensioning roller 128 and the deflection roller 130 (and also possibly a further deflection roller), to the car frame 99. The car frame-side guide or suspension of the balance rope is not illustrated in FIG. 3.

According to this embodiment, the balance rope 110 is not fixed to a suspension point of the car frame. Instead, the said balance rope is deflected at the car frame, in particular looped-through, and returned, for example via at least one further deflection roller 230, to the counterweight. At the counterweight 102, the returned balance rope 110 is fastened by way of its second end to a further suspension point 202a which is likewise not positioned centrally on the bottom face of the counterweight 102.

According to this embodiment, the suspension points 102a, 202a are therefore each formed off-centre on the bottom face of the counterweight or of the counterweight frame. This rope guidance or suspension allows length compensation between the part of the balance rope 110 which runs between the counterweight 102 (or the first suspension point 102a) and the deflection roller 130 (called the balance rope region 110a in the text which follows), and the balance rope region which runs between the deflection roller 230 and the counterweight 102 or the second suspension point 202a (called the balance rope region 110b in the text which follows).

The tensioning apparatus 120 according to the invention is also suitable for tensioning a balance rope 110 of this kind which is returned to the counterweight 102.

As an alternative, the balance rope 110 can be guided, for example, from the suspension point 99a on the car frame 99 to the counterweight, and returned from the said counterweight, analogously to the described manner, to the car frame.

In this case, the balance rope 110 is fastened to the counterweight such that length compensation between the balance rope regions 110a and 110b is possible. In this embodiment too, the balance rope is not fixed to a suspension point on the counterweight, but rather is deflected at the counterweight 102, in particular looped-through, and returned to the car frame via at least one further deflection roller. The returned balance rope is fastened to a further suspension point on the car frame.

The arrangement of the buffer beneath the counterweight is influenced by the described design of the balance rope tensioning apparatus. The counterweight buffer can be arranged above or next to the balance rope tensioning apparatus and depends on the space available in the individual case.

1.-10. (canceled)

11. A lift system comprising:
a car;
a counterweight that is movable on a shaft-side counterweight guide, wherein the car and the counterweight are connected by a balance rope; and
a balance rope tensioning apparatus that can tension the balance rope, the balance rope tensioning apparatus comprising a tensioning roller that is mounted on the shaft-side counterweight guide and movable along the shaft-side counterweight guide.

12. The lift system of claim 11 wherein the tensioning roller is movable vertically, independent of the counterweight.

13. The lift system of claim 11 wherein the tensioning roller of the balance rope tensioning apparatus beneath a movement path of the counterweight is movable on shaft-side counterweight guide.

14. The lift system of claim 11 wherein the tensioning roller is a first tensioning roller, wherein the balance rope tensioning apparatus comprises a second tensioning roller that cannot be moved along the shaft-side counterweight guide.

15. The lift system of claim 11 wherein the shaft-side counterweight guide comprises two rails.

16. The lift system of claim 11 wherein in a vertical projection on a horizontal plane, the tensioning roller is positioned outside a projection area of the car.

17. The lift system of claim 11 wherein the balance rope tensioning apparatus comprises a tensioning mass that is connected to the tensioning roller.

18. The lift system of claim 11 wherein the balance rope is fastened to a suspension point on the car and to a suspension point on the counterweight with a suspension ratio of 1:1.

19. The lift system of claim 11 wherein the balance rope is fastened to two suspension points on the counterweight, wherein the balance rope is guided to the car from a first suspension point and guided back from the car to a second suspension point.

20. The lift system of claim 11 wherein the balance rope is fastened to two suspension points on the car, where the balance rope is guided to the counterweight from a first suspension point and guided back from the counterweight to a second suspension point.
